(19) United States
(12) Patent Application Publication
(10) Pub. No.: US 2016/0188595 A1
(43) Pub. Date: Jun. 30, 2016

(54) Semantic Network Establishing System and Establishing Method Thereof

(71) Applicant: Jiang Chen, Rowland Heights, CA (US)

(72) Inventor: Jiang Chen, Rowland Heights, CA (US)

(21) Appl. No.: 14/583,593

(22) Filed: Dec. 27, 2014

(51) Int. Cl. G06F 17/30; G06N 5/02

(52) U.S. Cl. CPC G06F 17/3053; G06F 17/30867; G06N 5/022

(57) ABSTRACT

A semantic network establishing system includes an editing center, a translating center and a node detection center. The editing center generates at least a knowledge node and edits at least a semantic link for encoding a semantic relationship between the knowledge node and the related knowledge node. The translating center communicatively connects the editing center. The translating center acquires an editing content from the knowledge system and sends the editing content to the editing center for editing. The node detection center communicatively connects with the knowledge node, wherein the node detection center detects a state of said knowledge node for informing the user the state of the knowledge node, so that the user is encouraged to continuously edit.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to a knowledge system, and more particularly relates to a semantic network establishing system and establishing method thereof, which generates a knowledge node and creates the semantic relationship between the knowledge node and a second related knowledge node in such a manner as to establish a semantic network.

2. Description of Related Arts

A knowledge system provides users a way to collaboratively edit articles and share knowledge. Currently, faced with ever expanding amounts of data to process and decreasing budgets, the knowledge system is exploring ways to reduce costs and expand capacity. One avenue of particular interest is the possibility of enabling voluntary community participation in the management process through an open data system such as Wikipedia. In a knowledge management system, a large, motivated community is a crucial component. In the large, motivated community, active users and active editors are crucial components. So the manager of the community must seriously consider how to maintain the interest and participation of users and editors. Wikipedia is a classic knowledge system and has a large, motivated, voluntary community. Recently, the number of participating users and editors on Wikipedia has been significantly reduced. The fundamental reason is that editors on Wikipedia would not gain any reward or honor for their editing. Though voluntary editors don't really want any reward or honor, they need recognition from users to encourage the voluntary editors to edit or update more articles for sharing knowledge. Because voluntary editors lose interest in editing or updating articles, the users are obtaining less and less new knowledge from articles on Wikipedia, and as a result, there is less activity on Wikipedia. In other words, Wikipedia cannot provide a way for users to recognize the voluntary editors and their efforts. More specifically, editors may collaboratively edit an article. For example, the first editor edits several paragraphs of the article on Wikipedia. The second editor amends one paragraph edited by the first editor. The third editor adds several new paragraphs of the article on Wikipedia. But Wikipedia cannot identify each paragraph editor, so Wikipedia cannot give any paragraph editor any reward, honor, or recognition.

Wikipedia is increasingly used as a platform for collaborative data management, but its current technical implementation has significant limitations that hinder its use in various applications, especially in biocuration applications. A knowledge management system, such as Wikipedia, utilizes a loose connection to manage the relationship between articles. Specifically, while editors can easily link between two articles in Wikipedia to indicate a relationship, there is no way to indicate the nature of that relationship in a way that is computationally accessible to the system or to external developers. Wikipedia utilizes the hyperlink to establish a relationship between articles and to navigate users to visit related articles. In other words, users can visit the related articles through hyperlinks, but users don't know how one article is related to the other articles. For example, editors easily link an article about the 5-HT1A receptor to the article about a biological process of vasodilation through a hyperlink. Through the hyperlink, users just know there is a relationship between the article about the 5-HT1A receptor and the article about the biological process of vasodilation, but users don't know how the article about the 5-HT1A receptor is related to the article about the biological process of vasodilation. In other words, users may infer the possibility that the 5-HT1A receptor plays a role in the process of vasodilation based simply on the presence of a hyperlink connecting the two articles. However, such inferences are imprecise. In the worst case scenario, the article about the biological process of vasodilation has does not involve the 5-HT1A receptor.

A particular weakness of Wikipedia is that it is not designed to support the production of structured data, especially in biocuration activities. For example, one relevant objective might be to produce a list of all the genes related to a given biological process and also to a particular disease. Since there is no query system in Wikipedia, such lists can only be assembled manually; literally by writing them into a ‘list page’ that must be updated by hand. When the relationships between concepts are structured, for example in a database, it becomes trivial to produce such lists through dynamic queries. How to enable the inclusion of structured data in the context of Wikipedia and how to do so without the power to change its technical implementation is a big problem, and currently there is no solution.

Another weakness of Wikipedia is that Wikipedia doesn't provide the interaction between the audiences and the editors. In other words, after the audiences read the article; the audiences cannot comment on the article; the audiences cannot express their opinions about the article; the audiences cannot express what they want to know more specifically in the article. On the other hand, the editors don't know the feedback of the audiences about the article, the editors don't know whether the audiences like the article, whether the audiences have learned something from the article, which aspect of article needs to be more specific, and so on. So that the editors don't know how to continuous edit the article although the editors want to edit the article.

There are several knowledge systems, such as Wikipedia, Wordnet, Youtube, Instagram and Ask.com. Wikipedia and Wordnet are two classic knowledge systems. Wordnet can be considered as a combination of dictionary and thesaurus. Wordnet utilizes the hyperlink to establish a relationship between words. Word is a basic unit in Wordnet. However, vocabulary entry is a basic unit in Wikipedia. Wikipedia utilizes the hyperlink to establish a relationship between articles and to navigate users to visit related articles. But Wordnet or Wikipedia don't provide the function of ranking. In other words, Wordnet doesn't provide ranking words and Wikipedia doesn't provide ranking vocabulary entries, so the editors don't know which words/vocabulary entries are popular or which words/vocabulary entries are unpopular. Therefore, the editors don't have an opportunity to amend the content of words or the content of vocabulary entries, because the editors don't know the ranking of words or vocabulary entries. In other words, high ranking of words or vocabulary entries provides a goal of the editors to continuously edit, so that the knowledge systems maintain activity. However, Wordnet and Wikipedia don't provide the goal for the editors.

Wikipedia has a lot of vocabulary entries, but the accuracy and quality of vocabulary entries are doubtful. One of the reasons is that the audiences don't know who edited the vocabulary entries. In other words, Wikipedia doesn't provide the management of users' information. According to what we know, the editors' experiences may affect the accuracy and quality of the vocabulary, so if the editors' information, such as their background, educational experience, work experience, etc., can be know by the audiences, that will help the audiences to judge the accuracy and quality of the vocabulary entries. But Wikipedia doesn't provide the editors' information, so the audiences cannot judge the accuracy and quality of vocabulary entries according to the editors' information.

In addition, the operations of reading and editing are the basic operations in knowledge systems, such as Wikipedia and Wordnet, but the knowledge systems don't remind the users which content they have been read or edited. In other words, the users cannot manage knowledge in knowledge systems, so that when the users want to review the content of knowledge system edited by the users, the users need to search the content again. But if Wikipedia provides knowledge management, the user will benefit greatly. Unfortunately, Wikipedia doesn't provide such a function.

### SUMMARY OF THE PRESENT INVENTION

The present invention is advantageous in that it provides a semantic network establishing system, which provides an editing center to generate at least a knowledge node and allows the ability to edit a semantic link for encoding a semantic relationship between the knowledge node and a related knowledge node.

Another advantage of the invention to provide a semantic network establishing system, which provides a translating center to translate the semantic link to query the related knowledge node according to the semantic link.

Another advantage of the invention is to provide a semantic network establishing system, which provides an encouragement module to collect a feedback of the knowledge node for informing a corresponding editor, so that the editor is encouraged to continuously edit to maintain the activity of the knowledge system.

Another advantage of the invention is to provide a semantic network establishing system, which provides a semantic query center for executing queries that utilize said semantic relationships encoded in the semantic links.

Another advantage of the invention is to provide a semantic network establishing system, wherein the translating center provides a content acquisition module for acquiring the editing content from the knowledge system and sending the editing content to the editing center for editing.

Another advantage of the invention is to provide a semantic network establishing system, wherein the translating center provides a plurality of translating modules to be selected for translating the semantic link into corresponding format supported by the knowledge system.

Another advantage of the invention is to provide a semantic network establishing system, wherein the editing center provides a semantic editing tool for correcting and formatting the semantic link in the editing center.

Another advantage of the invention is to provide a semantic network establishing system, wherein the editing center provides a presentation module for enhancing the presentation effect of the editing content and eases the semantic link embedded into the editing content through the editing center.

Another advantage of the invention is to provide a semantic network establishing system, wherein the editing center provides a presentation module for generating an infobox displaying all of the semantic links discovered on the current displaying page.

Another advantage of the invention is to provide a semantic network establishing system, which provides a node generator for generating at least a knowledge node according to the editing content edited in the editing center.

Another advantage of the invention is to provide a semantic network establishing system, wherein the knowledge node further comprises a content portion and a property portion, the content portion stores the editing content, and the property portion stores a plurality of properties regarding said editing content for providing feedback to the encouragement module.

Another advantage of the invention is to provide a semantic network establishing system, wherein the editing center provides a categorizer, which categorizes the knowledge nodes to form at least a knowledge collection.

Another advantage of the invention is to provide a semantic network establishing system, wherein the semantic link comprises an identifier, wherein the translating center selects the translating module according the identifier, and the identifier is capable of being configured for applying to the corresponding knowledge system.

Another advantage of the invention is to provide a semantic network establishing system, wherein an encouragement module gives a corresponding independence point to the editor according to the feedback of the knowledge node edited by the user to encourage the user to continuously edit.

Another advantage of the invention is to provide a semantic network establishing system, wherein the knowledge node further comprises a comment portion to provide a plurality of opinion options to select.

Another advantage of the invention is to provide a semantic network establish system, wherein the comment portion provides a ranking the opinion option.

Another advantage of the invention is to provide a semantic network establishing system, which provides a node detecting center that gives a corresponding independence point to the editor according to the feedback of the knowledge node edited by the user for encouraging the user to continuously edit.

Another advantage of the invention is to provide a semantic network establishing system, wherein the node detecting center provides a ranking module for ranking the knowledge nodes.

Another advantage of the invention is to provide a semantic network establishing system, wherein the property portion provides a knowledge factor, and the ranking module ranks the knowledge nodes according to the knowledge factor of each of knowledge nodes.

Another advantage of the invention is to provide a semantic network establishing system, wherein the property portion provides a node view, and the ranking module ranks the knowledge nodes according to the node views of each of the knowledge nodes.

Another advantage of the invention is to provide a semantic network establishing system, wherein the ranking module provides a ranking standard module for selecting a ranking standard for comparing each of the knowledge nodes.

Another advantage of the invention is to provide a semantic network establishing system, wherein the node detecting center provides a user module, which provides an archive management module for managing the knowledge archive.

Additional advantages and features of the invention will become apparent from the description which follows, and may be realized by means of the instrumentalities and combinations particularly pointed out in the appended claims.

According to the present invention, the foregoing and other objects and advantages are attained by a semantic network establishing system, comprising:

an editing center generating at least a knowledge node and editing at least a semantic link for encoding a semantic relationship between the knowledge node and the related knowledge node, so that a semantic network is established through connecting the knowledge node and the related knowledge node; and

a translating center which communicatively connects said editing center and translates the semantic link for identifying the semantic relationship, in order to facilitate the semantic relationship with the related knowledge node.

In accordance with another aspect of the invention, the present invention comprises a semantic network establishing method, comprising the steps of:

(A) acquiring an editing content from said knowledge system through an editing center;

(B) editing the semantic link for encoding the semantic relationship in the editing content;

(C) generating at least a knowledge node; and

(D) detecting said knowledge node to acquire a state of the knowledge node.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 illustrates a block diagram of the semantic network establishing system according to a preferred embodiment of the present invention.

FIG. 2 illustrates a block diagram of the editing module of the semantic network establishing system according to the preferred embodiment of the present invention.

FIG. 3 illustrates a block diagram of the semantic link of the semantic network establishing system according to the preferred embodiment of the present invention.

FIG. 4 illustrates a schematic diagram of the editing user interface (UI) of the semantic network establishing system according to the preferred embodiment of the present invention.

FIG. 5 illustrates a schematic diagram of the structure of the relationship type category of the semantic establishing system according to the preferred embodiment of the present invention.

FIG. 6 illustrates a schematic diagram of presentation structure of the link type according to the preferred embodiment of the present invention.

FIG. 7 illustrates a flow chart of establishing the semantic network according to the preferred embodiment of the present invention.

FIG. 8 illustrates a block diagram of the node detection center according to another preferred embodiment of the present invention.

FIG. 9 illustrates a block diagram of the knowledge node according to another preferred embodiment of the present invention.

FIG. 10 illustrates a block diagram of the semantic network establishing system according to another preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

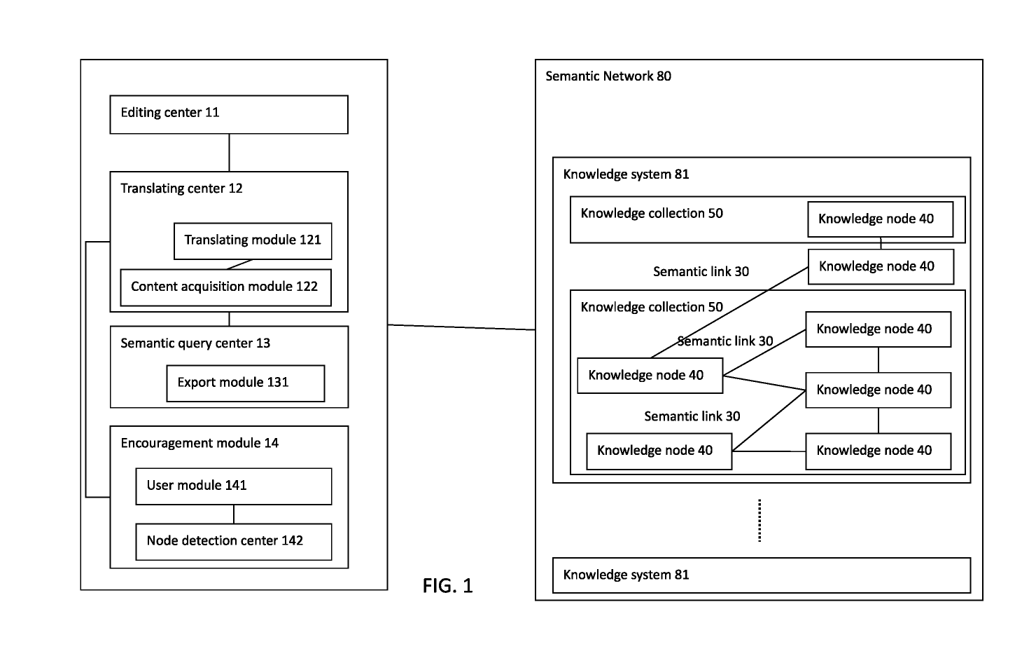

Referring to FIG. 1, a semantic network establishing system of the preferred embodiment of the present invention is illustrated. The semantic network establishing system comprises an editing center 11 and a translating center 12. The editing center 11 communicatively connects with the translating center 12. The editing center 11 allows an editor to edit a semantic relationship. Preferably, the editing center 11 is capable of editing a semantic link 30. The translating center 11 translates the semantic relationship into a standard format supported by the knowledge system providing the editing content, so that the user is capable of using the corresponding knowledge system to visit the edited semantic content. Preferably, the translating center 12 translates the semantic content into the standard HTML, so that the user is capable of using the browser to visit the edited semantic content. The translating center 12 communicatively connects with at least a knowledge system, such as Wikipedia. The translating center 12 acquires the editing content form the knowledge system and sends the editing content to the editing center 11 for editing the editing content. The translating center 12 is capable of translating the semantic relationship edited through the editing center 11 into the format supported by the corresponding knowledge system, so that the corresponding knowledge system supports the semantic relationship. In other words, the translating center 12 is capable of selecting the translating format to be suitable for the knowledge system provided the editing content. The editing content refers to an article, a paragraph of the article, multiple paragraphs of the article, a description of a concept, a description of a terminology or a semantic link, and so forth.

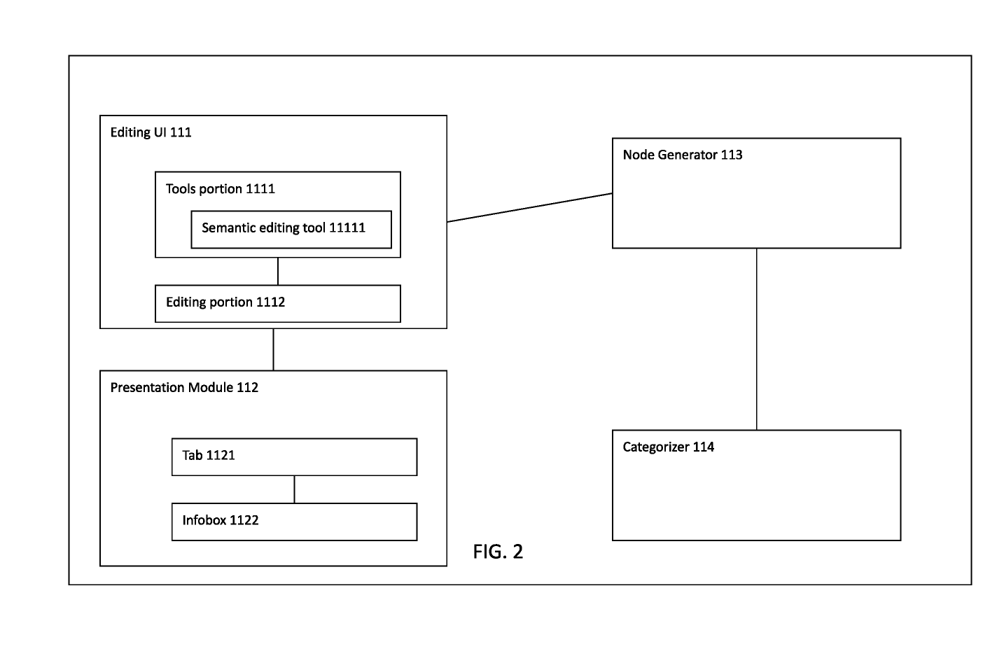

As shown in FIG. 2, the editing center 11 further comprises an editing UI (User Interface) 111 displaying the editing content for editing. The editing center 11 acquires the editing content from the knowledge system and displays the editing center 11 on the editing UI 111. The translating center 12 acquires the editing content form the knowledge system, and sends the editing content to the editing center 11. The editing content is displayed on the editing UI 111. As shown in FIG. 4 the editing UI 111 further comprises a tools portion 1111 and an editing portion 1112. The tools portion 1111 provides a plurality of editing tools for editing the editing content in the editing portion 1112. In the editing portion 1112, a hyperlink is edited for indicating the related content of the knowledge system. It is worth mentioning that the editing portion 1112 is capable of editing a semantic link 30 for encoding the semantic relationship. The semantic link 30 is capable of indicating the semantic type of the relationship between the editing content and the related content.

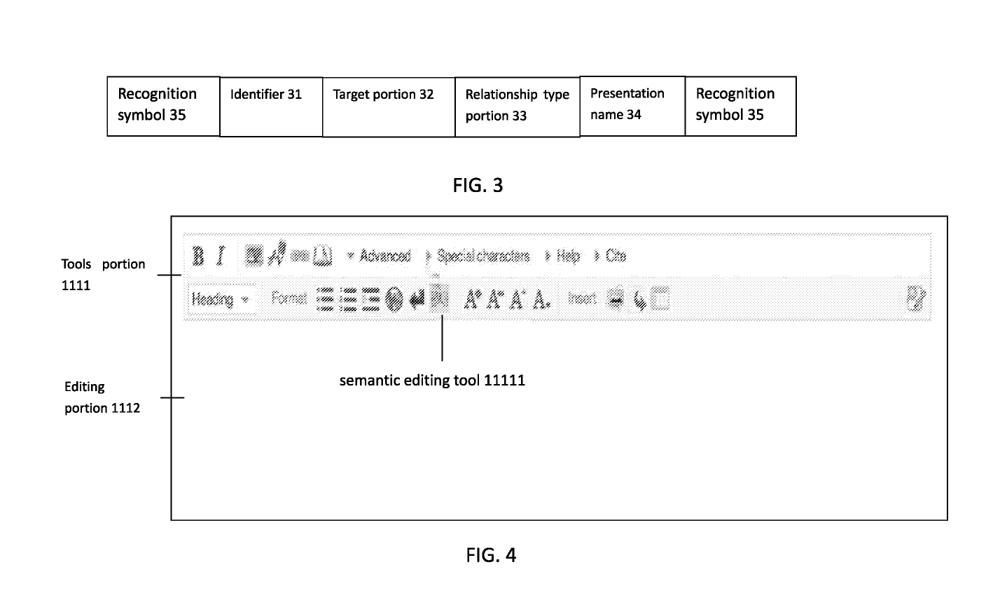

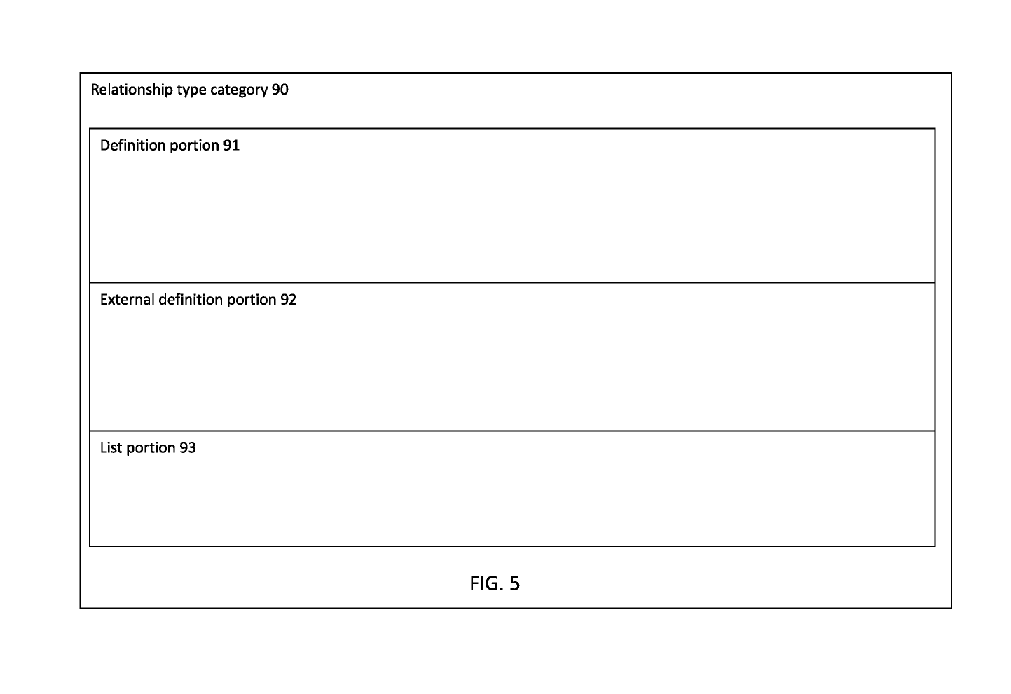

As shown in FIG. 3, the semantic link 30 further comprises an identifier 31, a target portion 32 and a relationship type portion 33. The identifier 31 indicates the type of the semantic link 30 of the knowledge system. The translating center 12 translates the semantic link 30 into the corresponding format supported by the knowledge system according to the identifier 31 of the semantic link 30. The target portion 32 indicates the related content linked by the semantic link 30. The relationship type portion 33 indicates the semantic type of the relationship between the editing content and the related content. The semantic link 30 further comprises a presentation name 34. The presentation name 34 displays the display name for the semantic link 30. Preferably, the presentation name 34 displays on the editing UI 111 or the browser as a label. It is worth mentioning that the presentation name 34 is optional. In other words, the semantic link 30 works normally without the presentation name 34. The semantic link 30 further comprises at least two recognition symbols 35 for recognizing the semantic link 30. The semantic link 30 is enclosed in the recognition symbols 35. Preferably, the recognition symbols are double-braces. It is worth mentioning that the operation on the editing content through the editing center 11 applies to original content in the knowledge system. For example, a paragraph of an article is acquired from Wikipedia, and the semantic link 30 is edited in the paragraph of the article. After the semantic link 30 is translated through the translating center 12, the translated semantic link 30 is embedded into original content in Wikipedia. The translating center 12 translates the editing content containing the semantic link 30 into the format supported by a browser. Preferably, the translating center 12 translates the editing content containing the semantic link 30 into the standard HTML. When the content containing the semantic link 30 is rendered in the knowledge system, the semantic link 30 operates in the same way as other hyperlinks, so the semantic link 30 does not disrupt any existing function in the knowledge system. But the semantic links 30 have consistent structure; it is helpful to structure the semantic relationship in the knowledge system, to improve the usage of the knowledge in the knowledge system. Whenever the semantic link 30 is embedded into the editing content of the knowledge system, the editing content containing the semantic link 30 is assigned to a relationship type category 90 of the knowledge system indicating the relationship type according to the relationship type portion 33 of the semantic link 30. A relationship type category 90 is created if the relationship type category 90 does not already exist and adds the relationship type category 90 to the editing content. As shown in FIG. 5, the relationship type category 90 comprises a definition portion 91, the definition portion 91 provides to define the meaning of the relationship. The relationship type category 90 further comprises an external definition portion 92. The external definition portion 92 displays the external definition from external website. The relationship type category 90 further comprises a list portion 93. The list portion 93 provides a list regarding the related relationship type portion 33 of the semantic link 30 in the knowledge system.

As shown in FIG. 4, the editing UI 111 provides a semantic editing tool 11111 to embed the semantic link 30 into the editing content. More specifically, the semantic editing tool is capable of correcting and formatting the semantic link 30. The semantic editing tool 11111 is arranged in the tools portion 1111. The editing center 111 further comprises a presentation module 112, which is capable of enhancing the presentation effect of the editing content and easing the semantic links 30 to embed the semantic links 30 into the editing content when editing the editing content in the editing center 11. To enhance the presentation effect of the editing content, the presentation module 112 discovers and collects the semantic links 30 on the editing content. It is worth mentioning that the presentation module 112 is capable of helping the browser to enhance the presentation effect. In other words, after the presentation module 112 is installed in the browser, the presentation module 112 discovers and collects the semantic links 30 on the displaying page, and then displays all of the semantic links 30 discovered on the displaying page. Preferably, the presentation module 112 generates a tab 1121. When the tab 1121 is clicked, an infobox 1122 is generated through the presentation module 112. The infobox 1122 displays all of the semantic links 30 discovered on the current displaying page on the browser. In order to facilitate to edit the semantic link 30, the editing center 11 provides the semantic link templates.

The editing center 11 further comprises a node generator 113. The node generator 113 generates at least a knowledge node 40 according to the editing content. The knowledge node 40 comprises a property portion 41 and a content portion 42. The property portion 41 records a plurality of node properties, such as the editor information, the creator information, the created time, the edited time, the node views and the original relationship type. The node views refer to the number of the knowledge node 40 that is visited by the audiences. Preferably, when the knowledge node is clicked, the property of node views is updated. The original relationship type refers to the relationship type of the knowledge system. The content portion 42 records the editing content. Preferably, the knowledge node 40 is generated after the editing content is saved through the editing center 11. When the user saves the editing content edited through the editing center 11, the editing center 11 generates the knowledge node 40 or updates the knowledge node 40. More specifically, when the user saves the editing content, the editing center 11 detects whether the editing content belongs to the existing knowledge node 40. If the editing content is a new creation, then the editing center 11 generates at least one of the knowledge nodes 40. It is worth mentioning that the generating number of the knowledge node 40 is capable of being arranged in the editing content through the editing center 11 by the editor. The editing center 11 detects the generating number of the knowledge node 40 and generates the knowledge node 40 corresponding to the generating number of the knowledge node 40. The property portion 41 of the knowledge node 40 stores the editor information and the knowledge node 40 edited time. The content portion 42 stores the editing content. After the knowledge node 40 is generated, the creator information and the created time are stored in the property portion 41. The editing content is stored in the content portion 42. If the editing content belongs to the existing knowledge node 40, the editing center 11 updates the existing knowledge node 40. If a part of the editing content belongs to the existing knowledge node 40, and another part of the editing content is new editing, then the existing knowledge node 40 is updated and the new knowledge node 40 is generated according to another part of the editing content. It is worth mentioning that if the editing content includes the semantic link 30, the semantic relationship type of the knowledge node 40 records the relationship type portion 33 of the semantic link 30. If the editing content includes multiple semantic links 30, then the semantic relationship type records each relationship type portion 33 corresponding to each the semantic links 30. If the editing content doesn't include the semantic link 30, then the semantic relationship type of the knowledge node 40 records nothing, but the relationship type of the knowledge node 40 records the relationship type of the editing content in the knowledge system. The editor is capable of controlling the generation of the knowledge node 40 according to the editing content through the editing center 11. If the editing content is an article, the content portion 42 of the knowledge node 40 may store the entire article. In other words, the editing center 11 generates the single knowledge node 40. If the editing content includes multiple concepts or multiple terminologies, the editing center 11 generates multiple knowledge nodes 40 according to the single content or the single terminology. The editing center 11 may generate multiple knowledge nodes 40 according to each paragraph of the editing content. The editing center 11 may generate multiple knowledge nodes 40 according to each of the semantic links 30.

Through the semantic link 30, the knowledge node 40 establishes the semantic relationship with the related knowledge node 40 according to the semantic type of the relationship of the semantic link 30. The knowledge node 40 is capable of containing a plurality of semantic links 30, and then the knowledge node 40 establishes a plurality of the semantic relationships with the related knowledge nodes 40 in such a manner that a semantic web is established. It is worth mentioning that the editing center 11 provides a plurality of semantic templates for editing, so that the efficiency of the editing semantic content is improved.

The translating center 12 further comprises a content acquisition module 122. The content acquisition module 122 communicatively connects with the editing UI 111. The content acquisition module 122 communicatively connects to at least a knowledge system, and acquires the editing content from the knowledge system. When the content acquisition module 122 acquires the editing content from the knowledge system, the content acquisition module 122 identifies the type of the knowledge system, and then sends the type of the knowledge system to the editing UI 111. The editing UI 111 selects the corresponding semantic link template according to the type of the knowledge system for editing, so that the efficiency of editing is improved. The content acquisition module 122 is capable of acquiring an article, a paragraph of the article, a concept described in the article or a terminology described in the article. It is worth mentioning that the category of the editing content in the knowledge system is acquired when the editing content acquires the editing content from the knowledge system, so that the editing content is saved, the node generator 113 generates the knowledge node 40, and the category of the editing content in the knowledge system is saved as the original relationship type property of the node knowledge 40. The editing center 11 further comprises a categorizer 114. The categorizer 114 categorizes the knowledge nodes 40 to form at least a knowledge collection 50 according to the original relationship type of the knowledge nodes 40. More specifically, the categorizer 114 acquires the category type of the knowledge nodes 40, and dispatches the knowledge nodes to the corresponding knowledge collection 50. If the knowledge node 40 does not belong to the existing knowledge collection, then another knowledge collection is created through the categorizer 114.

The translating center 12 further comprises a plurality of translating module 121. The translating center 12 identifies the type of the semantic link 30 through the identifier 31 of the semantic link 30. The translating center 12 selects the corresponding translating module 121 to translate the semantic link 30 in the editing content in accordance with the identifier 31 of the semantic link 30 in the editing content. If the editing content has no the semantic link 30, the translating center 12 acquires the type of the knowledge system from the content acquisition module 122. The translating center 12 selects the corresponding translating module 121 for translating the semantic link 30 in the editing content according to the type of the knowledge system. For example, the content acquisition module 122 of the editing center 11 acquires the editing content regarding genes from Wikipedia (a type of the knowledge system), and then sends the Wikipedia that the type of the knowledge system to the editing UI 111 of the editing center 11. [don't understand] The editing UI 111 selects the semantic template corresponding to the editing content of Wikipedia for editing semantic content, such as the semantic link 30. The SWL (Semantic Wiki Link) is utilized as the semantic link 30. The editing UI 111 configures ‘SWL’ as the identifier 31 of the semantic link 30 and configures ‘Gene’ as the relationship type 33. After the editing content is finished editing, the node generator 113 of the editing center generates the knowledge node 40. During the generating process of the knowledge node 40, the SWLs in the editing content are translated into the formant supported by the browser. The translating center 12 identifies the identifier 31 of the SWL as ‘SWL’, and then the translating center 12 selects the translating module 121 corresponding to the SWL. The SWL is translated into the format supported by the browser, and then is embedded into the editing content. Preferably, the SWL is translated into standard HTML, and then is embedded into the editing content. After the knowledge node 40 is generated, the categorizer 114 identifies the category type of the knowledge node 40 and categorizes the knowledge node 40 to form the knowledge collection 50. In this case, the knowledge node 40 is categorized to form the gene knowledge collection.

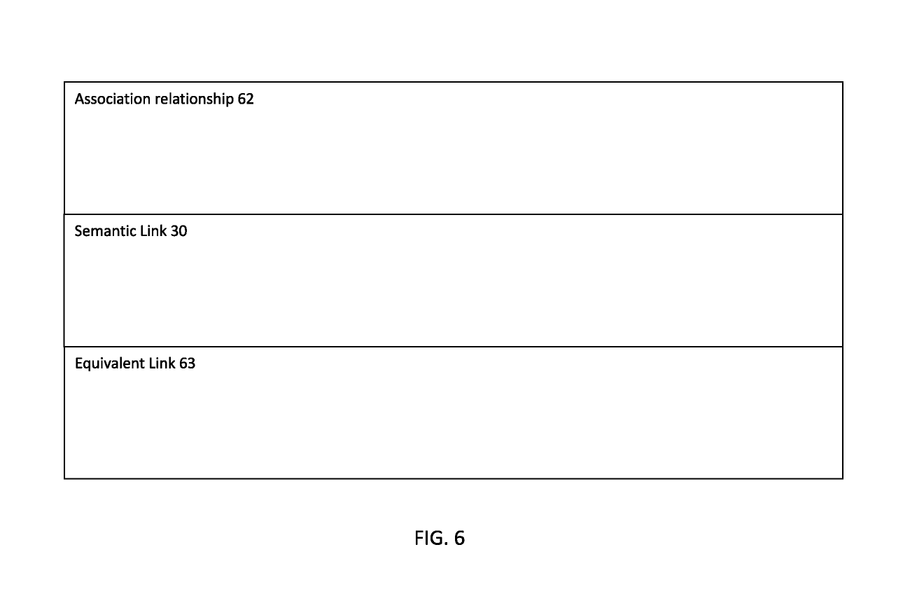

The semantic network management system further comprises a semantic query center 60. The semantic query center 60 communicatively connects with the translating center 12 and at least one knowledge collection 50 separately. The semantic query center 60 enables the users to execute queries that utilize the semantic relationships encoded in the semantic links 30 on the semantic network. Preferably, the semantic query center 60 executes queries that utilize the semantic relationships encoded in the semantic links 30 on the knowledge collections 50, such as the gene knowledge collection. The semantic query center 60 is capable of identifying the semantic relationship from the content portion 42 of the knowledge node 40. The semantic query center 60 detects the semantic link 30 of the editing content stored in the content portion 42 of the knowledge node 40 and converts the semantic link 30 to an equivalent link 63 supported by the semantic query center 60 through the translating center 12. The translating center 12 selects the corresponding translating module 121 to translate the semantic link 30 to the equivalent link. For example, the article on adenosine deaminase of the gene knowledge collection of Wikipedia contains the following semantic link 30 :{{SWL|target=hermolytic anemia|type=overexpression_results_in}}. When the article is transferred to the semantic query center 60, the semantic link 30 is translated to the equivalent link: [[overexpression_ression_in:: hemolytic anemia]]. This translation has two consequences in the context of the semantic query center 60. First, the semantic link 30 is visible through the ‘browse properties’ feature when viewing either the adenosine deaminase article or the article on hemolytic anemia. In other words, the corresponding translating module 121 is capable of being configured in the browser for displaying the semantic relationship in the browser. Second, the semantic relationship can be used in the queries such as ‘list all the genes whose over expression results in hemolytic anemia’. These semantic feathers are enabled as default behaviors of each the translating module 121 of the translating center 12. To implement the query ‘list all the genes whose over expression results in hemolytic anemia’ by decoupling the encoding of semantic relationships from the query and utilization of those relations. In addition, the semantic relationship type for the semantic link 30 is brought over and encoded as a translating module 121 property. This allows the users of the semantic query center 60 to view the textual definition of the semantic query center 60 and to navigate to related properties with external vocabularies, as shown in FIG. 6. Association relationship 62, Semantic link 30, and equivalent link 63 are displayed in their own displaying area.

It is worth mentioning that the standard hyperlink is translated into a default relationship type through the translating center 12. Preferably, in the knowledge collection 50 of Wikipedia, the default relationship type is configured to an association relationship 62 and represented as ‘is associated with’. For example, the semantic query center 60 executes the query regarding phosphorylation in the gene knowledge collection 50 of Wikipedia. If the content portion 42 of the knowledge node 40 contains a hyperlink linked to the article on phosphorylation, the hyperlink is detected through the semantic query center 60 and translated into [[is_associated_with::phophorylation]] through the translating center 12. Genes that code for kinases, for instance, nearly all include this particular link; translating it to the semantic link 30 allows the users to search for all genes that are associated with phosphorylation. The semantic query can then be expanded to find genes that are involved with phosphorylation and also in cancer, and so forth. These queries will become more powerful as these generic ‘is associated with’ relationships are made more precise.

It is worth mentioning that the default relationship type is capable of forming the root of the property hierarchy used in the semantic query center 60. This means that queries for x, where x ‘is_associated_with’ Y, will return results where x has ‘some more specific relationship’ with Y. It is worth mentioning that the semantic links 30 of the editing contents of the knowledge system are edited through the editing center 11, and then the queries in the semantic query center 60 are impacted immediately. But the editing contents brought over from the knowledge system are not editable on the semantic query center 60; any changes are made directly on the original content of the knowledge system. In other words, the semantic query center 60 is the mirroring of the knowledge system.

The semantic query center 60 further comprises an export module 61. The export module 61 extracts a structured content from the semantic query center 60. The structured content is capable of being utilized to perform queries over the encoded relationships and to integrate with the exported data; preferably, the form of the structured content is a Resource Description Framework (RDF). To facilitate integration with other linked data resource, all editing contents of the semantic query center 60 are annotated with their equivalents in a database. The database is a Web-accessible RDF database constructed automatically by extracting data from the consistently structured parts of the editing content of the knowledge system such as categories and ‘infoboxes’. For example, there is a taxonomy infobox that contains data about the scientific classification of organisms (e.g. kingdom, phylum, etc.). Where available, such data is extracted automatically and represented in the DBpedia system. The database makes no attempt to extract data from the hypertext of the editing content of the knowledge system and, as such, is entirely complementary to the data represented in embedded SWLs. Mapping the semantic query center 60 to the database provides the opportunity to very easily integrate the information derived from semantic links 30 embedded in editing content with what structured data does exist on Wikipedia. In addition, the database is a central point for ontology term mapping for the Semantic Web and, as a result, integration with it begins the process of integration with the many other knowledge bases that also map their concepts to it.

The semantic query center 60 provides equivalency links between relationship types in the semantic links and properties in external ontologies. Infoboxes display facts as key-value pairs rendered in a table typically visible on the upper right of the editing content of the knowledge system. This is achieved by processing semantic links 30 that appear on relationship type pages in Wikipedia and detecting when they contain the ‘equivalent’ relationship. To use the ‘equivalent’ the relation type portion 33 is configured as ‘equivalent’. For example, the relationship type page for ‘biomarker for’ in Wikipedia contains the SWL: {{SWL|type=equivalent|target=http://}}

In the RDF generated by the semantic query center 60, this is translated to establish an ‘equivalent Property’ link between the biomarker property of the semantic query center 60 and its equivalent in the external ontologies. Establishing such mappings facilitates the process of integrating RDF-based data assembled at multiple locations—in this case it would help to allow data from the semantic query center 60 to be aggregated with data from the external ontologies.

The semantic network establishing system further comprises a node detection center 70. The node detection center 70 communicatively connects with the knowledge node 40. The node detection center 70 is capable of acquiring the properties and contents of the knowledge node 40. The node detection center 70 processes the properties and contents of the knowledge node 40 and acquires the state of the knowledge node 40. The state of the knowledge node 40 is sent to the user who edited the knowledge node 40 for informing the user the state of the knowledge node 40, so that the editor is encouraged to improve the quality of the knowledge node 40. The node detection center 70 further comprises a user module 71 and a detection module 72. The user module 71 communicatively connects with the detection module 72. The user module 71 stores the user information. The detection module 72 detects the state of the knowledge node 40, and then acquires the user information from the user module 71 for informing the state of the knowledge node 40 edited by the user. It is worth mentioning that if the knowledge node 40 is edited by a different user at a different time, the detection module 72 sends the current state of the knowledge node 40 to each user who edited the knowledge node 40 for encouraging them to continuously edit the knowledge node 40. It is worth mentioning that the detection module 72 is capable of sending default amount of independent point to the user according to the state of the knowledge node 40 to encourage the user to continuously edit the knowledge node 40. If the knowledge node 40 is edited by multiple users, all of the users receive the independent point sent through the detection module 72. Preferably, the detection module 72 sends the independent point according to the node views property of the knowledge node 40. If the node detection module 72 detects the knowledge node is clicked, the node detection module 72 sends the default amount of the independent point to the user editing the knowledge node. If the content portion 42 of the knowledge node 40 is a paragraph of an article, then the paragraph is clicked, the node detection module 72 sends the default amount of the independent point to the user editing the knowledge node 40. If the content portion 42 of the knowledge node 40 is an article, then the article is clicked, the detection module 72 sends the default amount of the independent point to the user editing the knowledge node 40. If the content portion 42 of the knowledge node 40 is a description of a concept, then the description of the concept is clicked, the detection module 72 sends the default amount of the independent point to the user editing the knowledge node 40. If the content portion 42 of the knowledge node 40 is a semantic link, then the paragraph is clicked, the detection module 72 sends the default amount of the independent point to the user editing the knowledge node 40. In other words, if the knowledge node 40 receives a single action, such as click, slide, the detection module 72 sends the independent point to the user editing the knowledge node 40. It is worth mentioning that the detection module 72 is capable of being preset to detect the state of the knowledge node 40.

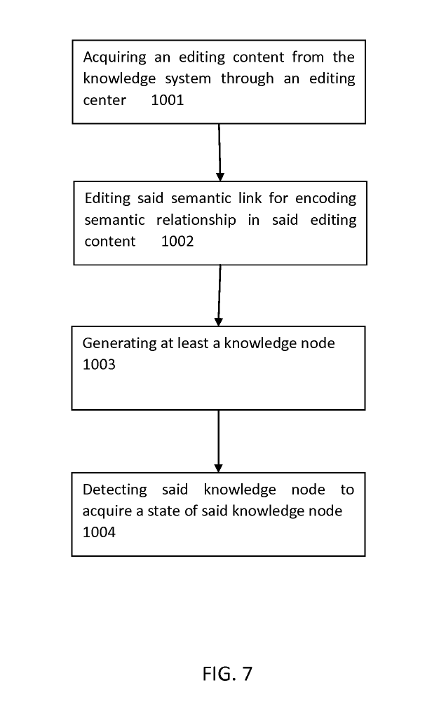

As shown in FIG. 7, a semantic network establishing method comprise the steps of:

Step 1001: acquire an editing content from the knowledge system through an editing center;

Step 1002: editing the semantic link for encoding a semantic relationship in the editing content;

Step 1003: generating at least a knowledge node; and

Step 1004: detecting the knowledge node to acquire a state of the knowledge node.

The step 1004 further comprises the steps of:

(A) acquiring the properties and contents of the knowledge node;

(B) processing the properties and contents of the knowledge node;

(C) acquiring the state of the knowledge node for informing the user the state of the knowledge, so that the user is encouraged to improve the quality of the knowledge node; and

(D) sending the default amount of the independent point to the user editing the knowledge node according to the state of the knowledge node.

The step (D) may be replaced with step (D1): sending the default amount of the independent point to the user editing the knowledge node when the knowledge node receives the single action.

The step 1001 further comprises the steps of:

(A.1) acquiring an editing content from the knowledge system through an editing center;

(A.2) identifying the type of the knowledge system and sending the type of the knowledge system to the editing UI of the editing center; and

(A.3) selecting the corresponding semantic link template according to the type of the knowledge system for the editing UI to edit for improving the efficiency of editing.

The Step 1002 further comprises the steps of:

(B.1) editing the semantic link for encoding the semantic relationship in the editing content;

(B.2) translating the semantic link into the corresponding format supported by the knowledge system according to the identifier of the semantic link;

(B.3) embedding the translated semantic link into the corresponding original content in the knowledge system; and

(B.4) assigning the editing content containing the semantic link to a relationship type category, if the relationship type category does not exist then the relationship type category is created and the relationship type category is added to the editing content.

Step (1003) further comprises the steps of:

(C.1) generating at least a knowledge node; and

(C.2) establishing the semantic relationship between the knowledge node and the related knowledge node.

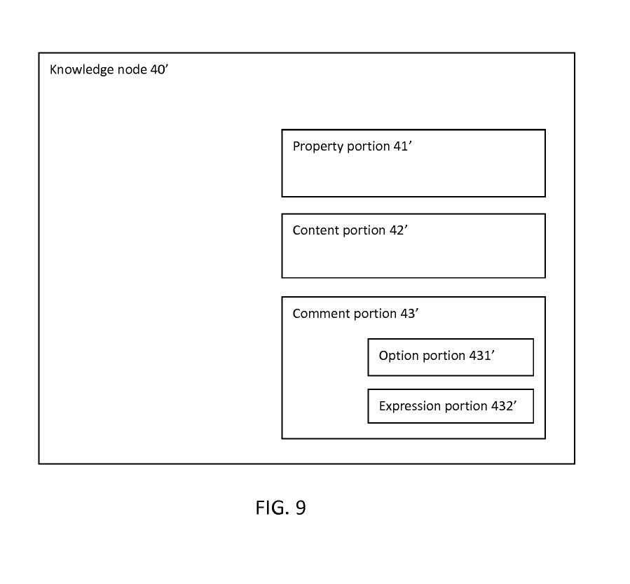

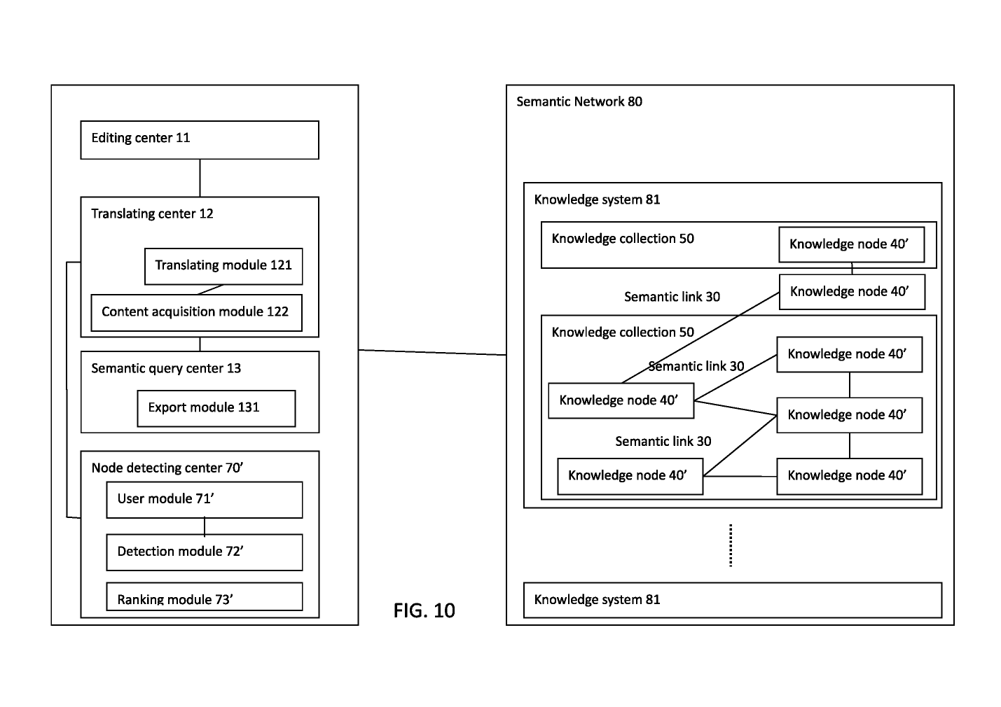

Referring to FIG. 9 and FIG. 10, a knowledge node 40′ of another preferred embodiment of the present invention is illustrated. The knowledge node 40′ comprises a property portion 41′, a content portion 42′ and a comment portion 43′. The property portion 41′ records a plurality of properties of the knowledge node 40′, such as the editor information, the creator information, the created time, the edited time, the node views, the original relationship type, the knowledge factor, and the parent. The node views refer to the number of times the knowledge node 40′ is visited by the users. It is worth mentioning that “when the knowledge node 40′ is visited” refers to when the knowledge node 40′ is clicked or pressed, as well as displayed on the screen or projected to an image, the user is able to acquire the editing content of the knowledge node 40′. Preferably, when the knowledge node 40′ is visited, the value of the node views adds one. The initial value of the node views of the knowledge node 40′ is zero. The original relationship type refers to the relationship type of the knowledge node 40′. The knowledge factor reflects the quality of the knowledge nodes 40′. If the knowledge node 40′ has a higher knowledge factor, the quality of the knowledge node 40′ is considered as better than other knowledge nodes 40′ with a lower knowledge factor. The knowledge factor is defined as f(x)=f(a)/f(b), wherein f(a) is defined as the number of times that the knowledge node 40′ is cited by the other knowledge nodes 40′ through the semantic link 30, and f(b) is defined as the total number of the knowledge nodes 40′. It is worth mentioning that the knowledge factor has a scope of comparison. The scope of comparison comprises the knowledge collection 50 and the knowledge system 81. The scope of comparison is capable of being configured by the user. In other words, the knowledge factor is capable of reflecting the quality of the knowledge nodes 40′ within the same knowledge collection 50 or the quality of the knowledge nodes 40′ within the same knowledge system 81. If the scope of comparison of the knowledge nodes 40′ is the knowledge collection 50′, then the knowledge factor is defined as the knowledge factor is defined as f(x)=f(a)/f(b), wherein f(a) is defined as the number of times that the knowledge node 40′ of the knowledge collection 50 is cited by the other knowledge nodes 40′ of the knowledge collection 50 through the semantic link 30, and f(b) is defined as the total number of the knowledge nodes 40′ of the knowledge collection 50. If the scope of comparison is the knowledge system 81, then the knowledge factor is defined as f(x)=f(a)/f(b), wherein f(a) is defined as the number of times that the knowledge node 40′ is cited by the other knowledge nodes 40′ of the knowledge system 81 through the semantic link 30, and f(b) is defined as the total number of the knowledge nodes 40′ of the knowledge system 81. Preferably, the default scope of comparison is the knowledge collection 50. It is worth mentioning that if the scope of comparison is changed, the knowledge factor will be reprocessed, and the knowledge factor has a new value.

The parent refers to the relationship between two knowledge nodes 40′. More specifically, the parent points out which knowledge node 40′ is the parent of the other knowledge node 40′. For example, editing a vocabulary entry in Wikipedia, when a vocabulary entry is created in Wikipedia, the node generator 113 generates the knowledge node 40′ according to the editing content of the vocabulary entry. It is worth mentioning that the property of the parent that is configured for identifying the knowledge node 40′ is the parent knowledge node 40′ of the vocabulary entry. If another user edits the vocabulary entry, the node generator 113 generates another knowledge node 40′ and the node generator 113 configures the property of the parent for identifying the knowledge node 40′ that is the parent node of another knowledge node 40′.

The content portion 42′ records the editing content. It is worth mentioning that the node generator 113 generates at least a knowledge node 40′ according to the editing content. The content portion 42′ is capable of editing the semantic link 30. It is worth mentioning that the content portion 42′ is capable of editing picture, video, audio, flash and/or etc.

The comment portion 43′ records comments of the knowledge node 40. In other words, the comment portion 43′ provides commenting on the editing content of the content portion 42′. The comment portion 43′ provides the users to state their opinions of the knowledge node 40′. It is worth mentioning that the comment portion 43′ is capable of editing the semantic link 30 so as to allow the users to provide information to support their opinions easily. The comment portion 43′ further comprises an option portion 431′ and an expression portion 432′. The option portion 431′ provides a plurality of opinion options for the user to express the opinions, such as a like option and a dislike option. For example, the option portion 431′ provides a like option and a dislike option for the users to express the attitude regarding the editing content. If the user likes the editing content, the audiences are capable of selecting the like option for supporting the editor who edited the editing content. Furthermore, the option portion 431′ is capable of displaying a number for showing how many people selected the corresponding option. The initial number of each of options is zero. After the like option is selected, the number of the like option is added by one. The number of the like option encourages the users continuously editing. If the users don't like the editing content, the users are capable of selecting the dislike option. After the dislike option is selected, the number of the dislike option is added by one. Through the number of the dislike option, the user who edited the editing content knows that the editing content needs to be amended, so that the user may amend the editing content. The initial number of the dislike option is zero. The option portion 431′ is capable of rating the opinion options so as to allow the users to utilize a rating method to express their opinions. For example, the option portion 431′ provides a plurality of opinion options, such as accuracy and understandability. The users are then capable of rating the opinion options for expressing their opinions. The higher ranking of the opinion option means the users agree with the opinion option more. It is worth mentioning that the users are capable of giving the opinion option a negative rating, when the users consider the editing content of the knowledge node 40′ does not match the opinion option. The expression portion 432′ provides the users the option to express their opinions freely. It is worth mentioning that the expression portion 432′ is capable of editing the semantic link 30 so as to allow the users to provide the information to support their opinions easily.

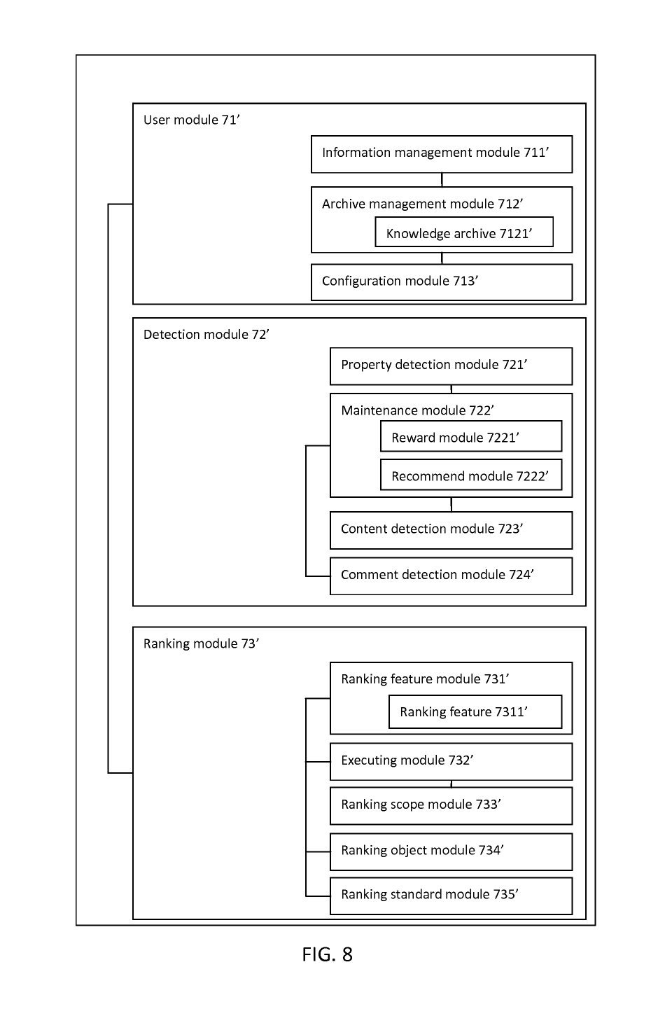

Referring to FIG. 8, a node detection center 70′ of another preferred embodiment of the present invention is illustrated. The node detection center 70′ further comprises a user module 71′ and a detection module 72′. The user module 71′ communicatively connects with the detection module 72′. The user module 71′ stores the user information. The detection module 72′ acquires the user information from the user module 71′. The detection module 72′ detects the knowledge node 40′ for acquiring the information of the knowledge node 40′, so that the detection module 72′ informs the information of the knowledge node 40′ to the users. For example, if the knowledge node 40′ is updated by the user, the detection module 72′ detects the knowledge node 40′ is updated, and then the detection module 72′ sends the updated information of the knowledge node 40′ to the user who is editing the knowledge node 40′ to informing the user the knowledge node 40′ is updated. The detection node 72′ therefore encourages the user who is editing the knowledge node 40′ to continuously edit the knowledge node 40′. Furthermore, the detection node 72′ is capable of informing the user who has visited the knowledge node 40′ that the knowledge node 40′ is updated so as to encourage the user to continuously visit the knowledge node 40′. It is worth mentioning that if the knowledge node 40′ is edited by different users at different times, the detection module 72′ sends the current state of the knowledge node 40′ to each user who edited the knowledge node 40′ to encourage them to continuously edit the knowledge node 40′.

The user module 71′ further comprises an information management module 711′ and an archive management module 712′. The information management module 711′ manages the information of the user, such as the reputation of the user, background of the user, education experiences of the user, and/or work experiences the user. After the editing content is edited, the information of the user who edited the editing content is capable of being published, so that the information of the user is capable of helping the users to determine the quality of the editing content. The information management module 711′ communicatively connects with the archive management module 712′. The archive management module 712′ manages at least a knowledge archive 7121′ of the user. More specifically, the archive management module 712′ creates the knowledge archive 7121′ for recording the knowledge acquired from the knowledge system 81. Furthermore, the archive management module 712′ creates the knowledge archive 7121′ for recording the knowledge acquired from the knowledge node 40′ of the knowledge collection 50′. The knowledge archive 7121′ is capable of editing the semantic link 30 for creating connection with the knowledge node 40′ and navigating the user to the knowledge node 40′ quickly. In other words, the user is capable of visiting the knowledge node 40′ easily through the semantic link 30. It is worth mentioning that through the semantic link 30, the archive management module 712′ is capable of connecting with other knowledge collections 50′. It is worth mentioning that the knowledge archive 7121′ records different knowledge from different knowledge nodes 40′ of different knowledge systems 81′ so as to establish a personal knowledge system of the user.

The detection module 72′ further comprises a property detection module 721′ and a maintenance module 722′. The property detection module 721′ communicatively connects with the maintenance module 722′. The property detection module 721′ detects the property portion 41′ of the knowledge node 40′, and then acquires the state of the knowledge node 40′. If the state of the knowledge node 40′ is visited, then the maintenance module 722′ acquires the user information from the information management module 711′ of the user module 71′ according to the state of the knowledge node 40′ acquired from the property module 721′. The maintenance module 722′ then informs the state of the knowledge node 40′ to the users who edited the knowledge node 40′ to encourage the users to continuously edit the knowledge node 40′. In other words, through encouraging the users to maintain the user activity, the user edits the knowledge node 40′ continuously. Furthermore, the maintenance module 722′ sends the default amount of the independent point to the user editing the knowledge node 40′ for maintaining the user activity and encouraging the user to continuously edit the knowledge node 40′. It is worth mentioning that if the knowledge node 40′ is edited by different users at different times, the detection module 72′ sends the current state of the knowledge node 40′ to each user who edited the knowledge node 40′ to encourage them to continuously edit the knowledge node 40′. In other words, if the knowledge node 40′ is edited by multiple users, all of the users receive the state of the knowledge node 40′ and/or the independent point sent through the maintenance module 722′. Preferably, the maintenance module 722′ sends the independent point according to the node views property of the knowledge node 40′. If the detection module 72′ detects the knowledge node 40′ is clicked, the maintenance module 722′ of the detection module 72′ sends the default amount of the independent point to the user editing the knowledge node 40′. The ‘click’ operation refers to when the knowledge node 40′ is clicked, the knowledge node 40′ is touched or pressed, or the knowledge node 40′ is displayed. It is worth mentioning that the user is capable of configuring the default amount of the independent point.

The detection module 72′ further comprises a content detection module 723′ for detecting the content portion 42′ of the knowledge node 40′. The content detection module 723′ detects whether the content portion 42′ of the knowledge is updated. If the content detection module 723′ is updated, the content detection module 723′ sends the information of the knowledge node 40′ of which the content portion 42′ is updated to the user module 71′. The user module 71′ searches the users to find out the user who has ever visited the knowledge node 40′ of which the content portion 42′ is updated. The user module 71′ then sends the information of the user to the maintenance module 722′. The maintenance module 722′ informs the user that the knowledge node 40′ which the user has visited is updated, so that the user is capable of visiting the knowledge node 40′ again. The content detection module 723′ communicatively connects with the archive management module 712′ of the user module 71′. The content detection module 723′ detects the content portion 42′ of the knowledge node 40′ is updated, and then the content detection module 723′ sends the information of the knowledge node 40′ of which the content portion 42′ is modified to the archive management module 712′. The archive management module 712′ searches the knowledge archives 7121′ of the users to find out the user who has ever visited the knowledge node 40′ of which the content portion 42′ is updated. The archive management 712′ sends the information of the user to the maintenance module 712′. And then the maintenance module 722′ informs the user that the knowledge node 40′ is updated, so that the user is encouraged to visit the knowledge node 40′ again.

It is worth mentioning that if the content detection module 723′ detects the content portion 42′ of the knowledge node 40′ as having no editing content, the content detection module 723′ sends the information of the knowledge node 40′ of which the content portion 42′ has no editing content to the archive management module 712′. The archive management module 712′ finds out the creator of the knowledge node 40′ according to the information of the knowledge node 40′ acquired from the content detection module 723′. The archive management module 712′ then sends the information of the creator to the maintenance module 722′. The maintenance module 722′ reminds the creator to edit the content portion 42′ of the knowledge node 40′. It is worth mentioning that the maintenance module 722′ is capable of recommending the knowledge node 40′, of which the content portion 42′ has no editing content, to other users to encourage other users to edit the knowledge node 40′ of which the content portion 42′ has no edited content, so that activity is maintained in the knowledge system 81.

The maintenance module 722′ further comprises a reward module 7221′ for encouraging the users to edit or visit the knowledge node 40′. The reward module 7221′ communicatively connects with the property detection module 721′. The reward module 7221′ receives the state of the knowledge node 40′ from the property detection module 721′. The reward module 7221′ acquires the users who have visited the knowledge node 40′ from the archive management module 712′. If the knowledge node 40′ is updated, the reward module 7221′ informs the users who have visited the knowledge node 40′ that the knowledge node 40′ is updated, so that the reward module 7221′ is capable of encouraging the users to visit the knowledge node 40′. When the user visits the knowledge node 40′, the property of node views of the knowledge node 40′ is changed. The reward module 7221′ receives the state of the knowledge node 40′ from the property detection module 721′, and then the reward module 7221′ informs the users who are editing the knowledge node 40′ in accordance with the state of the knowledge node 40′ to encourage the users to continuously to edit the knowledge node 40′. Furthermore, if the knowledge node 40′ is clicked, the reward module 7221′ sends the independent point to the user who is editing the knowledge node 40′ to reward the user, so that the user is actively editing the knowledge node 40′ continuously. The amount of the independent point is capable of being set through the reward module 7221′. If the knowledge node 40′ is edited by multiple users, all of the users receive the state of the knowledge node 40′ and/or the independent point sent through the reward module 7221′. Preferably, the maintenance module 722′ sends the independent point according to the node views of the knowledge node 40′.

The maintenance module 722′ further comprises a recommend module 7222′ for recommending the knowledge node 40′ which the content portion 42′ that has no editing content to the user, so that the users are capable of editing the knowledge node 40′ where the content portion 42′ has no editing content. The recommend module 7222′ communicatively connects with the content detection module 723′. The content detection module 7222′ detects the content portion 42′ of the knowledge node 40′. If the content portion 42′ of the knowledge node 40′ has not been edited, the recommend module 7222′ records the information of the knowledge node 40′ where the content portion 42′ has not been edited. The recommend module 7222′ then recommends the knowledge node 40′ with no edited content to the users to encourage the users to edit the knowledge node 40′ that has no edited content in the content portion 42′. Preferably, the recommend module 7222′ is capable of finding the creator who created the knowledge node 40′ from the information management module 711′ of the user module 71′, and then the recommend module 7222′ reminds the creating user to edit the content of the knowledge node 40′. It is worth mentioning that the recommend module 7222′ provides a default time for the creator to edit the knowledge node 40′ when the content portion 42′ has no edited content. If the creator doesn't finish editing the knowledge node 40′ when the content portion 42′ has no edited content during the default time, the recommend module 7222′ recommends the knowledge node 40′ to other users for editing. It is worth mentioning that the recommend module 7222′ is capable of recommending the suitable users to edit the knowledge node 40′ when the content portion 42′ has no edited content. The suitable users refer to the users who have work experience/education experience in the knowledge field with the same knowledge as the knowledge node 40′ having no edited content. The recommend module 7222′ searches the information management module 711′ of the user module 71′ to find the suitable users from the information management module 711′ of the user module 71′. It is worth mentioning that the recommend module 7222′ is capable of creating a recommended list of the knowledge node 40′ with the content portion 42′ having no edited content to the users for editing.

The node detecting center 70′ further comprises a ranking module 73′. The ranking module 73′ is capable of ranking the knowledge nodes 40′. The ranking module 73′ communicatively connects with the detection module 72′ and the user module 71′ separately. The ranking module acquires at least one ranking feature 7311′ of each of the knowledge nodes 40′ form the detection module 72′. And then the ranking module ranks the knowledge nodes 40′ according to the ranking feature 7311′. The ranking module is capable of acquiring the properties of the knowledge node 40′. The ranking module 73′ selects at least one property of the knowledge node as the ranking feature 7311′. The node detecting center 70′ further comprises a ranking feature module 731′ and an executing module 732′. The ranking feature module 731′ communicatively connects with the executing module 732′. The ranking feature module 731′ provides at least one ranking feature 7311′ for the user to select. After the ranking feature 7311′ is selected, the executing module 732′ ranks the knowledge node 40′ according to the ranking feature 7311′. The ranking feature module 731′ acquires the properties of the knowledge node 40′ through the property detection module 721′, so that the properties of the knowledge node 40′ are capable of being configured as the ranking features 7311′, such as the knowledge factor, node views, created time, edited time, and so on. For example, if ranking the knowledge nodes 40′ of the gene knowledge collection 50 of the Wikipedia, the ranking feature module 731′ acquires the properties of the knowledge node 40′ of the gene knowledge node 40′ of Wikipedia through the property detection module 721′. The ranking feature module 731′ provides the knowledge factor, the node views, the created time, the edited time, the original relationship type as the knowledge feature 7311′ for the user to select. If the knowledge factor is selected as the ranking feature 7311′, the executing module 732′ ranks the knowledge nodes 40′ of the gene knowledge collection 50 of Wikipedia in accordance with the knowledge factor of the knowledge nodes 40′. It is worth mentioning that the user is capable of selecting multiple ranking features through the ranking features module 731′. For example, if the knowledge factor and the node views are selected as the ranking features 7311′, firstly, the executing module 732′ ranks the knowledge nodes 40′ according to the knowledge factor of the knowledge node 40′. After the ranking the knowledge nodes 40′ according to the knowledge factor of the knowledge node 40′ is finished, if there are two or more knowledge node 40′ in which the values of each of the knowledge factors are the same, the executing module 732′ ranks each of the knowledge nodes 40′ in accordance with the node views of the knowledge node 40′. After ranking the knowledge nodes 40′ according to the node views of the knowledge node 40′, if there are two or more knowledge nodes 40′ in which the value of the node views are the same, the executing module 732′ ranks the knowledge nodes 40′ in the alphabetic order. It is worth mentioning that the ranking features module 731′ is capable of configuring the ranking priority of the ranking feature. The ranking feature 7311′ having a higher priority is ranked preferentially. In other words, the user is capable of configuring ranking priority for each ranking feature, so that the user is capable of adjusting the ranking result. Preferably, the knowledge factor has the highest ranking priority. The ranking module 73′ further comprises a ranking scope module 733′ for adjusting the ranking scope of the knowledge nodes 40′. The ranking scope module 733′ communicatively connects with the executing module 732′. The user is capable of selecting the ranking scope from the knowledge collection 50 from the knowledge system 81 or the semantic network 80. It is worth mentioning that when the ranking scope is changed, the value of the knowledge factor of each knowledge node 40′ will be updated. If the ranking feature 7311′ is the knowledge factor, the executing module 732′ ranks the knowledge nodes 40 according to the updated knowledge factor of the knowledge node 40′. The default ranking scope is knowledge collection. The executing module 732′ generates a ranking result after the ranking of the knowledge nodes 40′ is finished. When the categorizer 114 communicatively connects with said executing module 732′, the executing module 732′ is capable of categorizing the ranking result through the categorizer 114. In other words, the categorizer 114 acquires the ranking result from the executing module 732′, and then the categorizer 114 categorizes the ranking result, so that the ranking result is capable of being categorized for display. For example, if ranking the vocabulary entries in Wikipedia, after the vocabulary entries are finished being ranked through the ranking module 73′, the ranking result is categorized according to each knowledge collection 50 of Wikipedia through the categorizer 114.

It is worth mentioning that the executing module 732′ communicatively connects with the archive management module 712′. The executing module 732′ acquires the knowledge archive 7121′ from the archive management module 712′. The executing module 732′ analyzes the knowledge archive 7121′ for acquiring the knowledge nodes 40′ in which the user is interested. The executing module 732′ recognizes each knowledge collection 50 separately for each knowledge node 40′ o. The executing module 732′ categorizes the knowledge nodes 40′ into multiple ranking groups according to the knowledge collection 50 through the categorizer 114, and then the executing module 732′ ranks the ranking group firstly according to the knowledge collection 50 in which the user is interested. The executing module 732′ then ranks the knowledge nodes 40′ of each ranking group separately. Preferably, the knowledge nodes 40 in which the user in interested shows in the front of the ranking result.

The ranking module 73′ further comprises a ranking object module 734′ for selecting the ranking object. The ranking object comprises the knowledge node 40′, the vocabulary entry, the article, the word and so on. The user is capable of selecting the ranking object through the ranking object module 734′. The ranking object module 734′ communicatively connects the executing module 732′. For example, the vocabulary entry is selected as the ranking object in the gene knowledge collection 50 of Wikipedia. The executing module 732′ ranks the vocabulary entries of the gene knowledge collection 50 of Wikipedia. It is worth mentioning that the property detection module 721′ of the detection module 72′ identifies which knowledge nodes 40′ belong to the same vocabulary entry through the property of the parent of the knowledge node 40′, so that the executing module 732′ ranks the vocabulary entries in accordance with the ranking feature 7311′. More specifically, the executing module 732′ ranks the vocabulary entries in accordance with the properties of the parent knowledge node 40′ of the vocabulary entry.

The ranking module 73′ further comprises a ranking standard module 735′ for setting a ranking standard. The ranking standard module 735′ communicatively connects with the executing module 732′. The user is capable of selecting a knowledge node 40′, a vocabulary entry, an article, a word, a terminology or a concept as a ranking standard. For example, if a knowledge node 40′ of the knowledge collection 50 is set as the ranking standard, the executing module 732′ acquires the ranking feature 7311′ of the knowledge node 40′ through the property detection module 721′ of the detection module 72′. The executing module 732′ acquires the ranking feature 7311′ of each knowledge node 40′ through the property detection module 721′. The executing module 732′ compares the ranking feature 7311′ of each knowledge node 40′ with the ranking feature 7311′ of the knowledge node 40′ which is set as the ranking standard, and then the executing module 732′ acquires the corresponding comparison result of each knowledge node 40′. The executing module 732′ ranks the knowledge nodes 40′ in accordance with the corresponding comparison result of each knowledge node 40′.

The detection module 72′ further comprises a comment detection module 724′. The comment detection module 724′ detects the comment portion 43′ of the knowledge node 40′ for acquiring the content of the comment portion 43′ of the knowledge node 40′. More specifically, the comment detection module 724′ is capable of acquiring the rating of the knowledge node 40′ through detecting the option portion 431′ of the comment portion 43′. The ranking module 73′ communicatively connects with the comment detection module 724′. It is worth mentioning that the ranking module 73′ provides another method to acquire the ranking feature 7311′ of the knowledge node 40′. The ranking feature 7311′ of the knowledge node 40′ is defined as f(x)=(C(f(c)f(d)+f(e))/(f(g)+f(c)). Wherein C is defined as a constant, and the user is capable of setting C; f(c) is defined as the average value of rating for all knowledge nodes 40′; f(d) is defined as average rating of all knowledge nodes 40′; f(e) is defined as total rating of the knowledge node 40′; f(g) is defined as total number of comments of the knowledge node 40′. The executing module 732′ acquires the total rating of all the knowledge nodes 40′ through the comment detection module 732′. The executing module 732′ acquires the average value of rating for all the knowledge nodes 40′ through the comment detection module 732′. The executing module 732′ acquires the average rating of all the knowledge nodes 40′ through the comment detection module 732′. The executing module 732′ acquires the total number of the comment of the knowledge node 40′. The executing acquires the ranking feature 7311′ of each knowledge node 40′ through executing f(x). And then the executing module 732′ ranks the knowledge nodes 40′ according to the ranking feature 7311′ of each knowledge node 40′. It is worth mentioning that the executing module 732′ ranks the knowledge nodes 40′ according to the ranking scope configured through the ranking scope module 7313′. Another ranking method is capable of ranking the vocabulary entries of Wikipedia through the ranking module 73′. It is worth mentioning that the ranking module 73′ is capable of ranking the knowledge nodes 40′ according to Bayesian statistics.

The user module 71′ further comprises a configuration module 713′. The configuration module 713′ communicatively connects with the ranking module 73′, so that the user configures the ranking configuration, such as ranking feature, ranking scope, or ranking object. The users are capable of editing their own information and their own knowledge archive through the configuration module 713′. It is worth mentioning that the user is capable of customizing an UI (User Interface) through the configuration module 713′. If the user logs into the knowledge system 81, the user is able to utilize the customized UI. Furthermore, if the user logs into the knowledge system 81, the ranking module 73 is capable of acquiring the knowledge archive 7212′ of the user, so that the ranking result is suitable for the user. The executing module 732′ of the ranking module 73′ adjusts the ranking result according to the knowledge archive 7212′, so that the ranking result is suitable for the user. In other words, the user is capable of determining whether to log into the knowledge system 81. One skilled in the art will understand that the embodiments of the present invention as shown in the drawings and described above are exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A semantic network establishing system, comprising:
an editing center generating at least a knowledge node and editing at least a semantic link for encoding a semantic relationship between said knowledge node and said related knowledge node; and
a node detecting center communicatively connecting with said knowledge node and comprising a ranking module ranking said knowledge nodes through detecting each of said knowledge nodes.

2. The semantic network establishing system, as recited in claim 1, further to comprising a translating center communicatively connecting with said editing center and acquiring an editing content from the knowledge system and sending to said editing center for editing.

3. The semantic network establishing system, as recited in claim 1, wherein said ranking module further comprises a ranking feature module and an executing module, said ranking feature module communicatively connecting with said executing module, wherein said ranking feature module provides at least a ranking feature to select, said executing module ranking said knowledge nodes according to said ranking feature which is selected.

4. The semantic network establishing system, as recited in claim 1, wherein said ranking module further comprises a ranking feature module and an executing module, said ranking feature module communicatively connecting with said executing module, wherein said ranking feature module provides at least a ranking feature to select, said executing module ranking said knowledge nodes according to said ranking feature which is selected.

5. The semantic network establishing system, as recited in claim 3, wherein said node detecting center further comprises a detection module and a user module, said detection module communicatively connecting with said user module, wherein said user module stores the user information, after said knowledge node is updated, said detection module acquires the user information with respect to who is editing said knowledge node, and informs to the user who is editing said knowledge node of the updated information.

6. The semantic network establishing system, as recited in claim 4, wherein said node detecting center further comprises a detection module and a user module, said detection module communicatively connecting with said user module, wherein said user to module stores the user information, after said knowledge node is updated, said detection module acquires the user information with respect to who is editing said knowledge node, and informs to the user who is editing said knowledge node of the updated information.

7. The semantic network establishing system, as recited in claim 5, wherein said knowledge node further comprises a property portion and a content portion, said property portion records a plurality of properties of said knowledge node, said content portion records the editing content, wherein said content portion indicates related content through editing said semantic link, said ranking, said ranking module selects at least one property of said knowledge node as said ranking feature from said properties of said knowledge node.

8. The semantic network establishing system, as recited in claim 6, wherein said knowledge node further comprises a property portion and a content portion, said property portion records a plurality of properties of said knowledge node, said content portion records the editing content, wherein said content portion indicates related content through editing said semantic link, said ranking, said ranking module selects at least one property of said knowledge node as said ranking feature from said properties of said knowledge node.

9. The semantic network establishing system, as recited in claim 7, wherein said detection module further comprises a property detection module and a maintenance module, said property detection module communicatively connecting with said maintenance module, wherein said property detection module acquires said properties of said knowledge node from said property portion of said knowledge node for providing said properties as said ranking features to said ranking feature module, said maintenance module acquiring the user information from said user module.

10. The semantic network establishing system, as recited in claim 8, wherein said detection module further comprises a property detection module and a maintenance module, said property detection module communicatively connecting with said maintenance module, wherein said property detection module acquires said properties of said knowledge node from said property portion of said knowledge node for providing said properties as said ranking features to said ranking feature module, said maintenance module acquiring the user information from said user module.

11. The semantic network establishing system, as recited in claim 9, wherein said detection module further comprises a comment portion commenting on the editing content of said knowledge node, wherein said comment portion further comprises an option portion and an expression portion, wherein said option portion provides a plurality of opinion options for the user to select said opinion option, said expression portion allowing the user to edit information supporting the selected said opinion through editing said semantic link.

12. The semantic network establishing system, as recited in claim 10, wherein said knowledge node further comprises a comment portion commenting on the editing content of said knowledge node, where said comment portion further comprises an option portion and an expression portion, wherein said option portion provides a plurality of opinion options for the user to select said opinion option, said expression portion allowing the user to edit information supporting the selected said opinion through editing said semantic link.

13. The semantic network establishing system, as recited in claim 11, wherein said detection module further comprises a content detection module, said content module detects whether said content portion of said knowledge node having no edited content and sending the information of said content portion of said knowledge node having no editing content to said maintenance module, said maintenance module recommending the user to edit said content portion of said knowledge node having no edited content.

14. The semantic network establishing system, as recited in claim 12, wherein said detection module further comprises a content detection module, said content module detects whether said content portion of said knowledge node having no edited content and sending the information of said content portion of said knowledge node having no editing content to said maintenance module, said maintenance module recommending the user to edit said content portion of said knowledge node having no edited content.

15. The semantic network establishing system, as recited in claim 9, wherein said properties recorded in said property portion further comprises a knowledge factor, wherein said detection node acquires said knowledge factor of each of said knowledge nodes, said ranking feature module selecting said knowledge factor as said ranking feature, said executing module ranking said knowledge nodes according to said ranking feature of each of said knowledge nodes, wherein said knowledge factor is defined as f(x)=f(a)/f(b), wherein f(a) is defined as the number of times that said knowledge node is cited by other said knowledge nodes through said semantic link, and f(b) is defined as the total number of said knowledge nodes.

16. The semantic network establishing system, as recited in claim 10, wherein said properties recorded in said property portion further comprises a knowledge factor, wherein said detection node acquires said knowledge factor of each of said knowledge nodes, said ranking feature module selecting said knowledge factor as said ranking feature, said executing module ranking said knowledge nodes according to said ranking feature of each of said knowledge nodes, wherein said knowledge factor is defined as f(x)=f(a)/f(b), wherein f(a) is defined as the number of times that said knowledge node is cited by other said knowledge nodes through said semantic link, and f(b) is defined as the total number of said knowledge nodes.

17. The semantic network establish system, as recited in claim 9, wherein said properties recorded in said property portion further comprises a set of node views, said node views refer to the number of times said knowledge node is visited by said users, wherein said property detection module acquires said node views of each of said knowledge nodes, said ranking feature module selects said node views as said ranking feature, said ranking module ranks said knowledge nodes according to said ranking feature of each of knowledge nodes.

18. The semantic network establish system, as recited in claim 10, wherein said properties recorded in said property portion further comprises a set of node views, said node views refer to the number of times said knowledge node is visited by said users, wherein said property detection module acquires said node views of each of said knowledge nodes, said ranking feature module selects said node views as said ranking feature, said ranking module ranks said knowledge nodes according to said ranking feature of each of knowledge nodes.

19. The semantic network establish system, as recited in claim 11, wherein said option portion provides rating said opinion option which is selected, wherein said opinion option is capable of being given a negative rating.

20. The semantic network establish system, as recited in claim 12, wherein said option portion provides rating said opinion option which is selected, wherein said opinion option is capable of being given a negative rating.

21. The semantic network establishing system, as recited in claim 19, wherein said detection module further comprises a comment detection module detecting said comment portion of said knowledge node, wherein said executing module acquires said ranking feature through said comment detection module, wherein said ranking feature is defined as f(x)=(C(f(c) f(d)+f(e))/(f(g)+f(c)), wherein C is defined as a constant, f(c) is defined as the average number of rating for all knowledge nodes, f(d) is defined as average rating of all knowledge nodes, f(e) is defined as total rating of said knowledge node, f(d) is defined as total number of comments of said knowledge node.

22. The semantic network establishing system, as recited in claim 20, wherein said detection module further comprises a comment detection module detecting said comment portion of said knowledge node, wherein said executing module acquires said ranking feature through said comment detection module, wherein said ranking feature is defined as f(x)=(C(f(c) f(d)+f(e))/(f(g)+f(c)), wherein C is defined as a constant, f(c) is defined as the average number of rating for all knowledge nodes, f(d) is defined as average rating of all knowledge nodes, f(e) is defined as total rating of said knowledge node, f(g) is defined as total number of comments of said knowledge node.

23. The semantic network establishing system, as recited in claim 9, wherein said ranking module further comprises a ranking standard module, said ranking standard module setting a ranking standard for ranking said knowledge nodes, wherein said executing module acquires a corresponding comparison result of each of knowledge nodes through comparing said ranking feature of each of said knowledge nodes with said ranking feature of said ranking standard, and then said executing module ranking said knowledge nodes according to said corresponding comparison result.

24. The semantic network establishing system, as recited in claim 10, wherein said ranking module further comprises a ranking standard module, said ranking standard module setting a ranking standard for ranking said knowledge nodes, wherein said executing module acquires a corresponding comparison result of each of knowledge nodes through comparing said ranking feature of each of said knowledge nodes with said ranking feature of said ranking standard, and then said executing module ranking said knowledge nodes according to said corresponding comparison result.

25. The semantic network establishing system, as recited in claim 23, wherein said editing center further comprises a categorizer, said categorizer communicatively connecting with said executing module for categorizing a ranking result generated through said executing module.

26. The semantic network establishing system, as recited in claim 24, wherein said editing center further comprises a categorizer, said categorizer communicatively connecting with said executing module for categorizing a ranking result generated through said executing module.

27. The semantic network establishing system, as recited in claim 25, wherein said ranking module further comprises a ranking scope module and a ranking object module, said ranking scope module and said ranking object module communicatively connecting with said executing module, wherein said ranking scope allowing the user to select a ranking scope, said ranking object allowing the user to select a ranking object, said executing module ranking said ranking object within said ranking scope.

28. The semantic network establishing system, as recited in claim 26, wherein said ranking module further comprises a ranking scope module and a ranking object module, said ranking scope module and said ranking object module communicatively connecting with said executing module, wherein said ranking scope allowing the user to select a ranking scope, said ranking object allowing the user to select a ranking object, said executing module ranking said ranking object within said ranking scope.

29. The semantic network establishing system, as recited in claim 26, wherein said user module further comprises a configuration module, said configuration module communicatively connecting with said ranking module for configuring a ranking configuration.

30. The semantic network establishing system, as recited in claim 26, wherein said user module further comprises a configuration module, said configuration module communicatively connecting with said ranking module for configuring a ranking configuration.

31. The semantic network establishing system, as recited in claim 9, wherein the user module further comprises an information management module and an archive management, said information management module communicatively connecting with said archive management module, wherein said information management module manages the information of the user, and said archive management module creates at least a knowledge archive for recording the knowledge acquired from said knowledge node.

32. The semantic network establishing system, as recited in claim 10, wherein the user module further comprises an information management module and an archive management, said information management module communicatively connecting with said archive management module, wherein said information management module manages the information of the user, and said archive management module creates at least a knowledge archive for recording the knowledge acquired from said knowledge node.

33. The semantic network establishing system, as recited in claim 31, wherein the maintenance module further comprises a reward module, said reward module communicatively connecting with said property detection module, wherein if said knowledge node is clicked, said reward module sends the independent point to the user who is editing said knowledge node.

34. The semantic network establishing system, as recited in claim 32, wherein the maintenance module further comprises a reward module, said reward module communicatively connecting with said property detection module, wherein if said knowledge node is clicked, said reward module sends the independent point to the user who is editing said knowledge node.

35. A semantic network establishing method, comprising the steps of:
(a) acquiring an editing content from a knowledge system through an editing center;
(b) editing a semantic link for encoding a semantic relationship in said editing content;
(c) generating at least a knowledge node; and
(d) detecting said knowledge node to acquire a state of said knowledge node.

36. The semantic network establishing method, as recited in claim 35, wherein the step (d) further comprises the steps of:
(d.1) acquiring properties and contents of said knowledge node;
(d.2) processing said properties and contents of said knowledge node;
(d.3) acquiring a state of said knowledge node for informing a user said state of said knowledge, so that the user is encouraged to improve a quality of said knowledge node; and
(d.4) sending a default amount of an independent point to the user editing said knowledge node according to said state of said knowledge node.

37. The semantic network establishing method, as recited in claim 36, wherein the step (d) further comprises the steps of:
(d.1) acquiring properties and contents of said knowledge node;
(d.2) processing said properties and contents of said knowledge node;
(d.3) acquiring a state of said knowledge node for informing a user said state of said knowledge, so that the user is encouraged to improve a quality of said knowledge node; and
(d.4) sending a default amount of an independent point to the user editing said knowledge node when said knowledge node receives a single action.

38. The semantic network establishing method, as recited in claim 35, wherein the step (a) further comprises the steps of:
(a.1) identifying a type of said knowledge system and sending said type of said knowledge system to an editing UI of said editing center; and
(a.2) selecting a corresponding semantic link template according to said type of said knowledge system for said editing UI to edit for improving an efficiency of editing.

39. The semantic network establishing method, as recited in claim 38, wherein the step (b) further comprises the steps of:
(b.1) translating said semantic link into a corresponding format supported by said knowledge system according to an identifier of said semantic link;
(b.2) embedding a translated semantic link into a corresponding original content in said knowledge system; and
(b.3) assigning said editing content containing said semantic link to a relationship type category, if said relationship type category does not exist then a relationship type category is created and said relationship type category is added to said editing content.

40. The semantic network establishing method, as recited in claim 39, wherein the step (c) further comprises the steps of establishing a semantic relationship between said knowledge node and said related knowledge node.
